(19) United States
(12) Patent Application Publication
(10) Pub. No.: US 2021/0063015 A1
(43) Pub. Date: Mar. 4, 2021

(54) RECHARGEABLE INTELLIGENT ARC IGNITER

(71) Applicant: JIANGSU TIANWANG SOLAR TECHNOLOGY CO., LTD., Jiangsu (CN)

(72) Inventor: Jiawei FAN, Jiangsu (CN)

(73) Assignee: JIANGSU TIANWANG SOLAR TECHNOLOGY CO., LTD, Jiangsu (CN)

(21) Appl. No.: 16/479,605

(22) PCT Filed: Nov. 9, 2018
(86) PCT No.: PCT/CN2018/114755

§ 371 Date: Jul. 22, 2019

(30) Foreign Application Priority Data
Sep. 20, 2018 (CN) 201811102298.1

(51) Int. Cl. F23Q 3/01; F23Q 3/00

(52) U.S. Cl. CPC F23Q 3/01; F23Q 3/006

(57) ABSTRACT

A rechargeable intelligent arc igniter includes an ignition head and a handle. A front end of the handle is provided with a deformable ignition rod and an illuminating lamp. A front end of the deformable ignition rod is fixed with an ignition head. A printed circuit board is inlaid with an ignition switch and an illuminating lamp switch. A tail end of the handle is set as a flat semicircle, and is smoothly connected with the handle. A hook hole is arranged at a position concentric to the semicircle. A shell of the handle is provided with a circular ignition button and an illuminating lamp button corresponding to the ignition switch and the illuminating lamp switch. The illuminating lamp button is provided with a power indicator lamp. A side edge of the shell is provided with a USB charging interface, and a right side thereof is provided with a power switch.

### BACKGROUND

### Technical Field

The present invention relates to the field of igniters, and more particularly, to a rechargeable intelligent arc igniter.

### Description of Related Art

As an auxiliary product of a high-energy ignition device, an igniter can be used for igniting a barbecue oven, a cooker, etc. In the prior art, an ignition rod of the igniter is set as a straight rod or a foldable rod, and cannot be bent, so that ignition in some parts with limited space is difficult. A handle of a traditional igniter is usually made of aluminum alloy, which is easy to leak electricity and has poor safety performance. Moreover, it is difficult to determine an ignition position in a dark environment because there is no illuminating lamp. Ignition can be performed by directly pressing an ignition button, which will cause mis-operation usually and sometimes cause children to play by mistake and strike fire, thus causing potential safety hazards. In addition, it is also inconvenient to take and place the igniter.

### SUMMARY

The present invention is intended to provide a rechargeable intelligent arc igniter with simple structure and good safety performance to solve the technical problems above.

In order to achieve the technical object above and meet the technical requirement above, the following technical solution is used in the present invention. A rechargeable intelligent arc igniter comprises an ignition head and a handle. A front end of the handle is provided with a deformable ignition rod, a front end of the deformable ignition rod is connected and fixed with the ignition head through a fixing frame, and the front end of the handle is further provided with an illuminating lamp. A left end inside the handle is provided with an ignition coil, a right side of the ignition coil is provided with a printed circuit board, and the printed circuit board is inlaid with an ignition switch and an illuminating lamp switch. A right side of the printed circuit board is provided with a polymer battery, and the polymer battery is connected with the printed circuit board through a wire. A tail end of the handle is set as a flat semicircle, and is smoothly connected with the handle, and a hook hole is arranged at a position concentric to the semicircle. A shell of the handle is provided with an upper cover and a lower cover connected through a buckle, a surface of the upper cover is provided with a circular ignition button and an illuminating lamp button corresponding to the ignition switch and the illuminating lamp switch, and a right side of the illuminating lamp button is provided with a power indicator lamp. A side edge connecting the upper cover with the lower cover is provided with a USB charging interface, and a right side of the USB charging interface is provided with a power switch.

Preferably, the ignition head is set into two layers, an inner layer is made of ceramic, and an outer layer is made of zinc alloy.

Preferably, the deformable ignition rod is set in a linear type or a bent shape, a bending direction of the deformable ignition rod is any direction, and a bending angle of the deformable ignition rod is any angle.

Preferably, the shell of the handle is made of engineering plastic, and a surface of the shell is provided with fine grains.

Preferably, the power indicator lamp is set into four sections, which are respectively 100% electric quantity, 75% electric quantity, 50% electric quantity and 25% electric quantity from left to right.

The present invention has the beneficial effects. Compared with the traditional structure, the rechargeable intelligent arc igniter uses the polymer battery as power supply input with better safety performance. The printed circuit board is connected through the wire, and the printed circuit board has safety protection function, and overcurrent, overvoltage and overtemperature protection functions. The shell of the handle is made of engineering plastic, which effectively prevents electric leakage and is safer and more beautiful in appearance. The deformable ignition rod is suitable for various scenes and angles. The inner layer of the ignition head is made of ceramic and has the functions of releasing high temperature and insulating. The outer layer is made of zinc alloy, which not only prevents high temperature but also increases strength. The front end of the handle of the igniter is provided with the illuminating lamp, which is suitable for dark environments and is more humanized. An intelligent chip of the printed board circuit is used with delay protection function, short-circuit protection of the circuit and electric quantity display function are arranged, soft lithium battery is used, and charge and discharge protection, and total power supply protection are designed on the circuit, so as to be safer and more environment-friendly. A tail part is provided with the hook hole for convenient taking and placing of the igniter. The present invention has the advantages of simple structure, reasonable design, good safety performance, convenient operation, breaking of environmental restriction, suitability for various occasions, stable and firm structure, long service life, low maintenance rate and low cost.

### BRIEF DESCRIPTION OF THE DRAWINGS

FIG. 1 is a structural diagram of the present invention;

FIG. 2 is a front view of FIG. 1 of the present invention;

FIG. 3 is an A-A section view of FIG. 2 of the present invention; and

FIG. 4 is a top view of FIG. 2 of the present invention.

In the figures: 1 refers to ignition head, 2 refers to handle, 3 refers to ignition rod, 4 refers to fixing frame, 5 refers to illuminating lamp, 6 refers to ignition coil, 7 refers to printed circuit board, 8 refers to ignition switch, 9 refers to illuminating lamp switch, 10 refers to polymer battery, 11 refers to hook hole, 12 refers to shell, 13 refers to upper cover, 14 refers to lower cover, 15 refers to ignition button, 16 refers to illuminating lamp button, 17 refers to power indicator lamp, 18 refers to charging interface, and 19 refers to power switch.

### DESCRIPTION OF THE EMBODIMENTS

In order to make the objects, technical solutions and beneficial technical effects of the present invention more clearly, the present invention is further described hereinafter with reference to the drawings and the detailed embodiments.

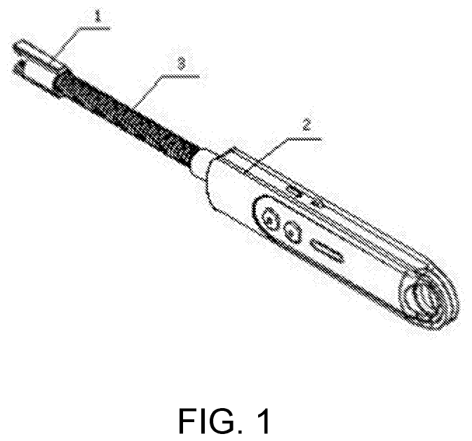

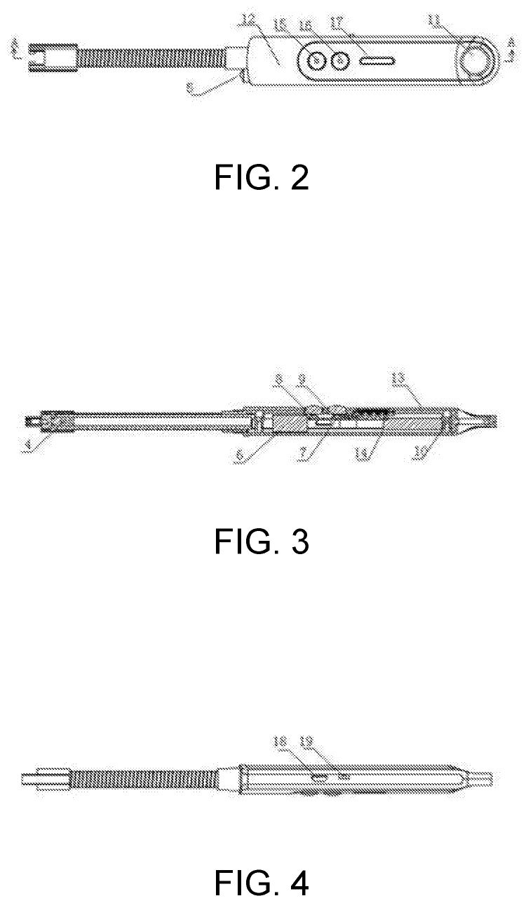

In FIGS. 1 to 3, a rechargeable intelligent arc igniter comprises an ignition head 1 and a handle 2. A front end of the handle 2 is provided with a deformable ignition rod 3, a front end of the deformable ignition rod 3 is connected and fixed with the ignition head 1 through a fixing frame 4, and the front end of the handle 2 is further provided with an illuminating lamp 5. A left end inside the handle 2 is provided with an ignition coil 6, a right side of the ignition coil 6 is provided with a printed circuit board 7, and the printed circuit board 7 is provided with an ignition switch 8 and an illuminating lamp switch 9. A right side of the printed circuit board 7 is provided with a polymer battery 10, and the polymer battery 10 is connected with the printed circuit board 7 through a wire. A tail end of the handle 2 is set as a flat semicircle, and is smoothly connected with the handle 2, and a hook hole 11 is arranged at a position concentric to the semicircle. A shell 12 of the handle 2 is provided with an upper cover 13 and a lower cover 14 connected through a buckle, a surface of the upper cover 13 is provided with a circular ignition button 15 and an illuminating lamp button 16 corresponding to the ignition switch 8 and the illuminating lamp switch 9, and a right side of the illuminating lamp button 16 is provided with a power indicator lamp 17. A side edge connecting the upper cover 13 with the lower cover 14 is provided with a USB charging interface 18, and a right side of the USB charging interface 18 is provided with a power switch 19.

The ignition head 1 is set into two layers, an inner layer is made of ceramic, and an outer layer is made of zinc alloy. The deformable ignition rod 3 is set in a linear type or a bent shape, a bending direction of the deformable ignition rod 3 is any direction, and a bending angle of the deformable ignition rod 3 is any angle.

The shell of the handle 2 is made of engineering plastic, and a surface of the shell is provided with fine grains. The power indicator lamp 17 is set into four sections, which are respectively 100% electric quantity, 75% electric quantity, 50% electric quantity and 25% electric quantity from left to right.

During specific implementation, a distance between the ignition head and an ignition position is 4 mm to 6 mm, the handle is made of ABS engineering plastic, a built-in buckle mode is used in the upper and lower covers to improve the firmness of the product, various matching colors can be plated, and the power switch is provided with opening and closing functions to increase the safety of the product. The polymer battery is used in the product as power input and is connected with a PCB circuit board through the wire, the PCB board has safety protection function, and overcurrent, overvoltage and overtemperature protection functions, the PCB board is automatically turned off when an ignition time is more than one minute, with delay protection function, short-circuit protection of the circuit and electric quantity display function are also arranged, soft lithium battery is used, and charge and discharge protection, and total power supply protection are designed on the circuit, so that the present invention is safer and more environment-friendly.

Ignition is controlled by the power switch and the ignition button at the same time, the power switch is firstly pushed to ON when ignition is performed, the power indicator lamp is on, and then the ignition switch is lightly pressed to ignite. Ignition cannot be realized only by turning on the power switch or pressing the ignition switch. When illumination is needed, an LED illuminating lamp button is lightly pressed to realize illumination.

The embodiments above are merely for clearly illustrating the present invention, but are not intended to limit the embodiments. Those skilled in the art can make other different forms of changes or variations on the basis of the descriptions above, and it is not necessary and impossible to exhaust all the embodiments here, while obvious changes or variations derived therefrom shall still fall within the protection scope of the present invention.

1. A rechargeable intelligent arc igniter, comprising an ignition head and a handle, wherein a front end of the handle is provided with a deformable ignition rod, a front end of the deformable ignition rod is connected and fixed with the ignition head through a fixing frame, and the front end of the handle is further provided with an illuminating lamp; a left end inside the handle (2) is provided with an ignition coil, a right side of the ignition coil is provided with a printed circuit board, and the printed circuit board is provided with an ignition switch and an illuminating lamp switch; a right side of the printed circuit board is provided with a polymer battery, and the polymer battery is connected with the printed circuit board through a wire; a tail end of the handle is set as a flat semicircle, and is smoothly connected with the handle, and a hook hole is arranged at a position concentric to the semicircle; a shell of the handle is provided with an upper cover and a lower cover connected through a buckle, a surface of the upper cover is provided with a circular ignition button and an illuminating lamp button corresponding to the ignition switch and the illuminating lamp switch, and a right side of the illuminating lamp button is provided with a power indicator lamp; and a side edge connecting the upper cover with the lower cover is provided with a USB charging interface, and a right side of the USB charging interface is provided with a power switch.

2. The rechargeable intelligent arc igniter according to claim 1, wherein the ignition head is set into two layers, an inner layer is made of ceramic, and an outer layer is made of zinc alloy.

3. The rechargeable intelligent arc igniter according to claim 1, wherein the deformable ignition rod is set in a linear type or a bent shape, a bending direction of the deformable ignition rod is any direction, and a bending angle of the deformable ignition rod is any angle.

4. The rechargeable intelligent arc igniter according to claim 1, wherein the shell of the handle is made of engineering plastic, and a surface of the shell is provided with fine grains.

5. The rechargeable intelligent arc igniter according to claim 1, wherein the power indicator lamp is set into four sections, which are respectively 100% electric quantity, 75% electric quantity, 50% electric quantity and 25% electric quantity from left to right.
